(19) United States
(12) Patent Application Publication
(10) Pub. No.: US 2011/0048889 A1
(43) Pub. Date: Mar. 3, 2011

(54) Clutch Plate Having Reinforced Spline Teeth

(75) Inventors: David Vierk, Mokena, IL (US); Tim Krzyskowski, Orland Park, IL (US); Steven Kowal, Naperville, IL (US)

(73) Assignee: BorgWarner, Inc.

(21) Appl. No.: 12/857,010

(22) Filed: Aug. 16, 2010

Related U.S. Application Data
(60) Provisional application No. 61/238,340, filed on Aug. 31, 2009.

(51) Int. Cl. F16D 13/70

(52) U.S. Cl. 192/107 R

(57) ABSTRACT

A clutch plate for transmitting torque from a driving member to a driven member may include an annular body disposed around an axis and defining inner and outer edges, the annular body having a thickness “t”. A plurality of spline teeth may project radially from the annular body. Each spline tooth may include a tab extending from the annular body and a flap superposed over the tab. Each spline tooth may further have a thickness “T” approximately twice the body thickness “t”. The flap may be formed integrally with the tab, in which case the flap may be folded over a fold line to superpose the flap and tab. The fold line may extend substantially circumferentially about the axis.

### CROSS-REFERENCE TO RELATED APPLICATION

This application is a non-provisional claiming priority under 35 USC §119 (e) to U.S. Provisional Patent Application No. 61/238,340 filed on Aug. 31, 2009.

### FIELD OF THE DISCLOSURE

The present disclosure generally relates to torque transmission components, and more particularly relates to clutch plates.

### BACKGROUND OF THE DISCLOSURE

Torque transmission members such as clutch plates are widely known in the art. In vehicles, for example, various types of clutches have been used to transmit torque, such as an automatic transmission which may use multiple clutches to engage or disengage selected gearsets, thereby to obtain a desired gear ratio. The clutches provided for this purpose are typically friction plate clutches, which include a plurality of inner or drive plates that are splined to a rotatable hub. A housing or case is coaxially aligned with the hub and supported for rotation independent of the hub. A plurality of outer or driven plates are splined to the housing or case and are interposed between the drive plates, such that the drive and driven plates are alternately arranged on a common axis. The drive plates include a friction material on one or both sides of the plates. An actuator, such as a hydraulic piston, applies a pressure force that presses the drive and driven plates into engagement, thereby permitting torque to be transferred from the hub to the housing.

The above-described clutch plates typically use spline teeth to couple the plate to an associated rotatable member. The spline teeth are configured to slide along grooves formed in the rotatable member. Additionally, the spline teeth provide the points of contact between the clutch plate and the rotatable member, and therefore they encounter a significant amount of contact stress. In most conventional clutch plates, the spline teeth are formed as extensions of a central, annular body. Accordingly, the thickness of the entire clutch plate is typically selected according to the amount of contact stress expected at the spline teeth. This may result in the body portion of the clutch plate being oversized, which may increase clutch plate weight and rotating inertia, thereby adversely impacting clutch design. Additionally, thicker clutch plates may require additional space, thereby increasing the size of the transmission or other component in which they are used.

### SUMMARY OF THE DISCLOSURE

In accordance with one aspect the disclosure, a clutch plate is provided for transmitting torque from a driving member to a driven member. The clutch plate may include an annular body disposed around an axis and defining inner and outer edges, the annular body having a thickness “t”. A plurality of spline teeth may project radially from the annular body, each spline tooth including a tab extending from the annular body and a flap superposed over the tab, in which each spline tooth has a thickness “T” approximately twice the body thickness “t”.

According to other aspects of this disclosure, a clutch plate may include an annular body disposed around an axis and defining inner and outer edge, and a plurality of spline teeth projecting radially from the annular body. Each spline tooth may have a tab extending from the annular body, a flap superposed over the tab, and a joint extending between the tab and the flap. The joint may define a fold line extending substantially circumferentially about the body axis.

According to further aspects of this disclosure a clutch plate may include an annular body disposed around an axis and defining inner and outer edges, the annular body having a thickness “t”, and a plurality of spline teeth projecting radially from the annular body. Each spline tooth may have a tab aligned with and extending from one of the inner and outer edges of the annular body, each tab including first and second side edges, a flap superposed over the tab so that each spline tooth has a thickness “T” approximately twice the body thickness “t”, each flap including first and second side edges, and a joint extending between the tab and the flap, the joint defining a fold line extending substantially circumferentially about the body axis. Each tab and flap have substantially the same overall shape so that each spline tooth includes a first composite side edge formed by the tab first edge and flap first edge and a second composite side edge formed by the tab second side edge and the flap second side edge.

These and other aspects and features of the disclosure will become more apparent upon reading the following detailed description when taken into consideration in conjunction with the accompanied drawings.

### BRIEF DESCRIPTION OF THE DRAWINGS

FIG. 1 is a schematic representation of a clutch assembly including inner and outer clutch plates constructed according to the present disclosure.

FIG. 2 is a plan view of an inner clutch plate used in the clutch assembly of FIG. 1.

FIG. 3 is a side elevation view, in cross-section, of a portion of the inner clutch plate taken along line 3-3 of FIG. 2.

FIG. 4 is a plan view of an outer clutch plate used in the clutch assembly of FIG. 1.

FIG. 5 is a perspective view, in partial cross-section, of the outer clutch plate taken along line 5-5 of FIG. 4.

While the present disclosure is susceptible to various modifications and alternative constructions, certain illustrative embodiments thereof are shown in the drawings and are described below in detail. It should be understood, however, that there is no intention to limit the present disclosure to the specific forms disclosed, but on the contrary, the intention is to cover all modifications, alternative constructions, and equivalents falling within the spirit of the scope of the present disclosure.

### DETAILED DESCRIPTION

A clutch plate is disclosed herein that includes reinforced spline teeth. The clutch plate includes a body portion having a thickness, and the spline teeth have a thickness that is approximately twice the thickness of the body portion. In certain embodiments, each spline tooth may include a tab portion and a flap portion that is superposed over the tab portion. The flap portion may be joined to the tab portion by a circumferential fold line. The increased thickness of the spline teeth reduces contact stress in the spline teeth while permitting a reduced thickness body portion, thereby reducing overall clutch plate weight and associated rotating inertia to improve clutch performance. Additionally, the smaller body portion thickness reduces the amount of space required for the torque transmission component in which the clutch plate is used.

Referring now to the drawings, FIG. 1 provides a schematic representation of a clutch assembly 20 used in a torque transmission component, such as an automatic transmission 22 for a vehicle. It is to be understood that the automatic transmission 22 is but one example of the setting in which the clutch assembly 20 may be used. Other areas of a transmission, vehicle, machine tool, or other machine could also advantageously employ its teachings as will be readily understood by one of ordinary skill in the art.

As shown in FIG. 1, the transmission 22 may include a drive shaft 24 adapted to rotate about an axis 26, which is itself powered by the motive force of an engine (not shown) of a vehicle (also not shown). A hub 28 is attached to and rotates with the drive shaft 24. The hub 28 may be provided as a simple annular flange coupled to the drive shaft 24 or it may be configured to provide additional features or capabilities, such as a one-way clutch. An exterior peripheral surface of the hub 28 may be formed with grooves 30. The transmission 22 may also include a case or housing 32 which is mounted coaxially with the drive shaft 24 and is supported for rotation about the axis 26 independent of the drive shaft 24. The housing 32 may also be formed with grooves 33. According to this embodiment, the drive shaft 24 is the driving or input member while the housing 32 is the driven or output member.

Referring still to FIG. 1, the clutch assembly 20 may include a plurality of clutch plates which use friction to transfer torque from the hub 28 to the housing 32. One or more inner clutch plates 38 may be slidably coupled to the hub 28. Each inner clutch plate 38 may include friction surfaces 40 on both sides of the plate. Alternatively, only one side of each inner friction plate may include a friction surface 40. Additionally, one or more outer clutch plates 42 may be slidably coupled to the housing 32 and positioned such that each outer clutch plate 42 is disposed between adjacent inner clutch plates 38. Each outer clutch plate 42 may include a friction surface on one or both sides of the plate.

The inner and outer clutch plates 38, 42 are allowed to slide in an axial direction while remaining attached to and rotating with the hub 28 and housing 32, respectively. Accordingly, the plates 38, 42 are movable between an unengaged position, in which the plates 38, 42 do not contact each other, and a torque transmitting position, in which the plates 38, 42 engage each other with sufficient force to transmit torque from the inner plates 38 to the outer plates 42. An actuator 44 may be operatively coupled to the clutch plates 38, 42 to move them between the unengaged and torque transmitting positions.

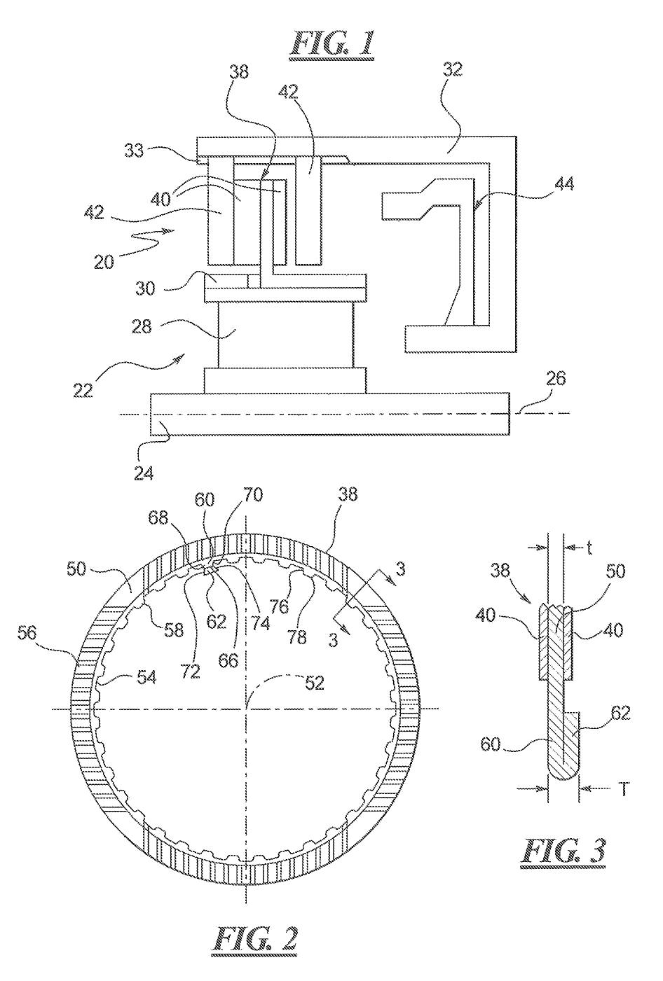

The inner clutch plate 38 is shown in greater detail in FIGS. 2 and 3. In the illustrated embodiment, the inner clutch plate 38 includes an annular body 50 disposed around an axis 52. The body 50 includes an inner edge 54 and an outer edge 56. A plurality of spline teeth 58 project inwardly from the body inner edge 54 and are configured to slidably engage the grooves 30 formed in the hub 28. As best shown in FIG. 3, the body 50 has a thickness “t”.

Each spline tooth 58 may have a greater thickness than the body 50 to reduce contact stresses during torque transmission. In the illustrated embodiment, each spline tooth 58 includes a tab 60 and a flap 62. The tab 60 may be aligned with and extend inwardly from the body 50. The flap 62 is superposed over the tab 60. The tab 60 and flap 62 may be coupled by a joint 64 that defines a fold line 66 extending circumferentially about the body axis 52. The tab 60 and flap 62, therefore, may be formed integrally with the body 50, with the flap 62 being folded over to overlie the tab 60. Accordingly, each spline tooth 58 may have a thickness “T” that is approximately twice the body thickness “t”.

One of the spline teeth 58 is shown in FIG. 2 prior to the flap 62 being folded over the tab 60. According to the illustrated embodiment, the tab 60 includes first and second side edges 68, 70. The fold line 66 forms a circumferential inner edge of the tab 60. The flap 62 similarly has first and second side edges 72, 74. The fold line 66 may form a circumferential outer edge of the flap 62. The tab 60 and flap 62 may be formed with substantially identical shapes. In the illustrated embodiment, the tab 60 and flap 62 have an involute gear shape, with the side edges having arcuate shapes that taper inwardly toward the fold line 66. Alternatively, the tab 60 and flap 62 may have straight-tooth gear shapes, or other alternative shapes suitable for transmitting rotation to or from the associated shaft.

When the flap 62 is folded over the tab 60, the resulting spline tooth 58 has first and second composite side edges 76, 78. The first composite side edge 76 is formed by the juxtaposition of the tab first side edge 68 and the flap first side edge 72, while the second composite side edge 78 is similarly formed by the tab second side edge 70 and the flap second side edge 74. The tab 60 and flap 62 may have substantially the same overall shapes so that the resulting first and second composite side edges 76, 78 of each spline tooth 58 are substantially contiguous and smooth, thereby to reduce localized areas of stress and more efficiently transmit torque from the torque transmission component to the clutch plate, or vice versa.

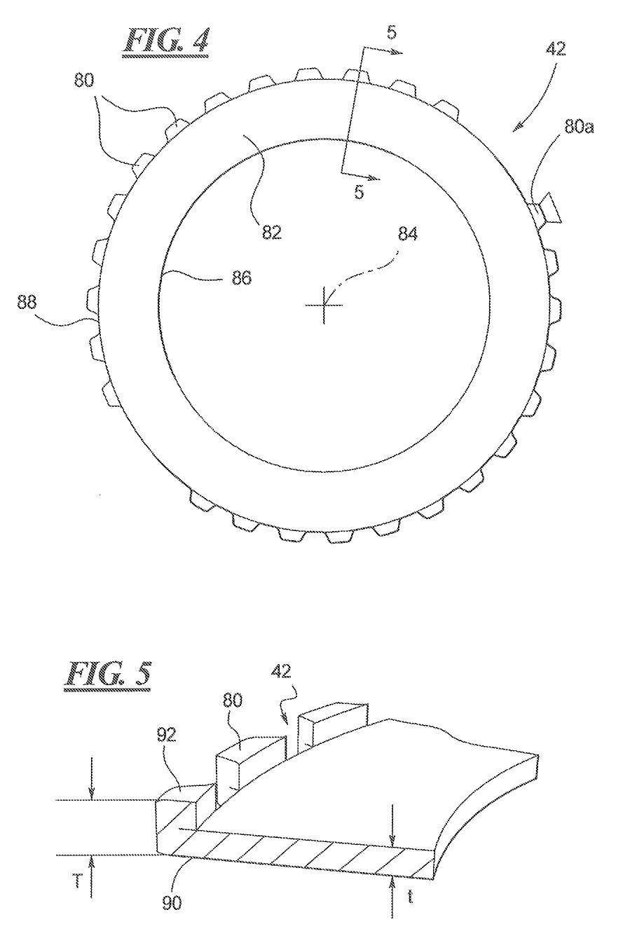

FIGS. 4 and 5 show an outer clutch plate 42 in greater detail. The outer clutch plate 42 is substantially similar to the inner clutch plate 38, except it includes radially outwardly projecting spline teeth 80 configured to slidably engage the grooves formed in the housing 32.

More specifically, the outer clutch plate 42 includes an annular body 82 disposed about an axis 84. The body 82 includes an inner edge 86 and an outer edge 88. The spline teeth 80 extend outwardly from the body outer edge 88. As best shown in FIG. 5, each spline tooth 80 may include a tab 90 and a flap 92. One of the spline teeth 80a is shown with an unfolded flap 92 in FIG. 4. Accordingly, each spline tooth 80 may have a thickness that is approximately twice that of the body 82.

Any of the spline tooth embodiments discussed above may further include an optional fastener for holding the flap in place against the tab. The fastener may be provided in any of form suitable for securing the flap in the folded position, including, but not limited to, staking, gluing, welding, and riveting.

While the foregoing embodiments are described as including a flap that is integrally provided with the tab, it will be appreciated that the flap may be provided as a separate component which is then fastened to the tab. Accordingly, the term “superposed” as used herein and in the claims includes portions of an integral component or two separate components that are folded or otherwise placed adjacent or in contact with one another.

The foregoing provides a clutch plate that can advantageously be used in a vehicle transmission or other torque transfer application. The clutch plate includes spline teeth that are reinforced by having a thickness that is larger than that of a body portion, thereby reducing contact stress in the spline teeth. The clutch plates disclosed herein further permit the use of a reduced thickness body portion for a given application, thereby reducing overall clutch plate weight and associated rotating inertia to improve clutch performance. Additionally, the smaller body portion thickness reduces the amount of space required for the torque transmission component in which the clutch plate is used.

What is claimed is:

1. A clutch plate, comprising:
an annular body disposed around an axis and defining an inner edge and an outer edge, the annular body having a thickness “t”;
a plurality of spline teeth projecting radially from the annular body, each spline tooth including a tab extending from the annular body and a flap superposed over the tab, in which each spline tooth has a thickness “T” approximately twice the body thickness

2. The clutch plate of claim 1, in which the tab and the flap are integrally formed.

3. The clutch plate of claim 2, in which each spline tooth includes a joint extending between the tab and the flap, the joint defining a fold line extending substantially circumferentially about the body axis.

4. The clutch plate of claim 1, in which each tab includes first and second side edges, in which each flap includes first and second side edges, and in which each spline tooth includes a first composite side edge formed by the tab first edge and flap first edge and a second composite side edge formed by the tab second side edge and the flap second side edge.

5. The clutch plate of claim 1, in which the flap and the tab of each spline tooth have substantially the same involute shape.

6. The clutch plate of claim 1, in which each spline tooth projects radially outwardly from the annular body outer edge.

7. The clutch plate of claim 1, in which each spline tooth projects radially inwardly from the annular body inner edge.

8. A clutch plate, comprising:
an annular body disposed around an axis and defining an inner edge and an outer edge;
a plurality of spline teeth projecting radially from the annular body, each spline tooth including a tab extending from the annular body, a flap superposed over the tab, and a joint extending between the tab and the flap, the joint defining a fold line extending substantially circumferentially about the body axis.

9. The clutch plate of claim 8, in which the spline teeth are integrally formed with the annular body.

10. The clutch plate of claim 8, in which each tab includes first and second side edges, in which each flap includes first and second side edges, and in which each spline tooth includes a first composite side edge formed by the tab first edge and flap first edge and a second composite side edge formed by the tab second side edge and the flap second side edge.

11. The clutch plate of claim 8, in which the flap and the tab of each spline tooth have substantially the same involute shape.

12. The clutch plate of claim 8, in which the annular body has a thickness “t”, and in which each spline tooth has a thickness “T” approximately twice the body thickness “t”.

13. The clutch plate of claim 8, in which each spline tooth projects radially outwardly from the annular body outer edge.

14. The clutch plate of claim 8, in which each spline tooth projects radially inwardly from the annular body inner edge.

15. A clutch plate, comprising:
an annular body disposed around an axis and defining an inner edge and an outer edge, the annular body having a thickness “t”;
a plurality of spline teeth projecting radially from the annular body, each spline tooth including:
a tab aligned with and extending from one of the inner and outer edges of the annular body, each tab including a first side edge and a second side edge;
a flap superposed over the tab so that each spline tooth has a thickness “T” approximately twice the body thickness “t”, each flap including a first side edge and a second side edge; and
a joint extending between the tab and the flap, the joint defining a fold line extending substantially circumferentially about the body axis;
wherein each tab and flap have substantially the same overall shape so that each spline tooth includes a first composite side edge formed by the tab first edge and the flap first edge, and a second composite side edge formed by the tab second side edge and the flap second side edge.
